(19) United States
(12) Patent Application Publication
(10) Pub. No.: US 2020/0000072 A1
(43) Pub. Date: Jan. 2, 2020

(54) SWIVEL FOR USE IN A FISHING RIG

(71) Applicants: Raul Gonzalez, Miami, FL (US); Shay Danzig, Tavernier, FL (US)

(72) Inventors: Raul Gonzalez, Miami, FL (US); Shay Danzig, Tavernier, FL (US)

(21) Appl. No.: 16/439,171

(22) Filed: Jun. 12, 2019

Related U.S. Application Data
(60) Provisional application No. 62/691,311, filed on Jun. 28, 2018.

(51) Int. Cl. A01K 83/06; A44B 13/00

(52) U.S. Cl. CPC A01K 83/06; A44B 13/00

(57) ABSTRACT

A fishing tackle device for use in making a dead bait fishing rig includes first and second eyelets rotatably connected to opposite ends of a central barrel member and each of the eyelets and the central barrel member being cooperatively structured and disposed to allow each of the eyelets to spin independently of the central barrel member and one another. At least one of the eyelets includes a coating material applied thereto and forming a membrane that closes the eyelet. In at least one embodiment, the coating material includes a rubberized composition. The formed membrane is adapted for punctured passage of a pointed end and barb of a fishing hook therethrough while the membrane remains in frictional engagement with the shank of the hook. The opposite eyelet may allow for attachment of rigging wire thereto.

This non-provisional patent application is based on provisional patent application Ser. No. 62/691,311 filed on Jun. 28, 2018.

### BACKGROUND OF THE INVENTION

### Field of the Invention

The present invention relates to fishing rigs and, more particularly, to an improved swivel for receiving a hook through an eyelet of the swivel, wherein the eyelet is provided with a coating that allows for passage of the hook therethrough without damaging the hook point or barb while also preventing unwanted movement of the hook relative to the swivel.

### Discussion of the Related Art

Swivels are commonly used when making a fishing rig and are often provided as a barrel swivel having a central barrel member and opposite eyelets that are able to freely spin or rotate relative to the opposite eyelet and the barrel so that the fishing line, leader and rig does not become twisted or entangled when bait is moved through the water. Barrel swivels are commonly used in conjunction with a hook that is passed through one of the eyelets of the barrel swivel to rig dead bait, such as a ballyhoo rig. When using a barrel swivel for this type of fishing rig, the rigging wire is attached to one eyelet of the barrel swivel while a hook is passed through the opposite eyelet for attachment to the dead bait.

A common problem encountered when passing a hook through the eyelet of a barrel swivel is the difficulty in getting the pointed end and barb of the hook through the eyelet without damaging the hook point or barb. To avoid damage to the hook point and barb, many anglers choose a barrel swivel having a larger eyelet. However, the larger eyelet results in a good deal of play between the hook and the eyelet which creates unwanted sliding movement of the hook through the eyelet when the dead bait is attached to the rig. This can result in the hook backing out of the swivel while trolling the bait.

Accordingly, there remains a need for an improved swivel that allows for easy passage of a hook through an eyelet of the swivel without damaging the hook point or barb, and further wherein the hook does not easily move through the eyelet and back out of the eyelet once rigged to the bait.

### BRIEF DESCRIPTION OF THE DRAWINGS

For a fuller understanding of the nature of the present invention, reference should be made to the following detailed description taken in conjunction with the accompanying drawings in which:

FIG. 1 is a top plan view of the improved swivel of the present invention shown with one eyelet attached to the rigging wire and the opposite eyelet having a coating forming a membrane that closes the eyelet but allows passage of a hook therethrough in a manner that holds the hook without damaging the hook point and barb when passing through the eyelet;

FIG. 2 is a side elevational view, in partial cross section, showing one coated eyelet of the swivel of the present invention in cross section and a fishing hook positioned for passage through the membrane coating that fills the opening of the eyelet, and wherein the pointed end of the fishing hook is positioned just below the membrane coating;

FIG. 3 is an isolated side elevational view, shown in partial cross section, showing the point and barb of the fishing hook passed through the membrane coating across the eyelet of the swivel of the present invention;

FIG. 4 is an isolated top plan view, in partial cross section, showing the pointed end and barb of the fishing hook punctured through the membrane coating of the coated eyelet of the swivel of the present invention; and

FIG. 5 is an isolated side elevational view showing the swivel of the present invention, and a fishing hook fitted to a dead bait with the rigging wire wrapped around the base of the bill and through the eye socket of the dead bait to effectively secure the swivel and fishing hook to the dead bait, thereby completing the fishing rig.

Like reference numerals refer to like parts throughout the several views of the drawings.

### DETAILED DESCRIPTION OF THE PREFERRED EMBODIMENT

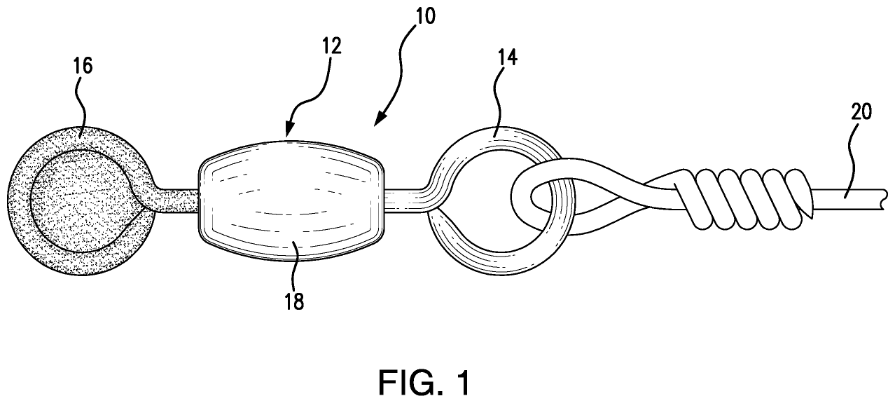

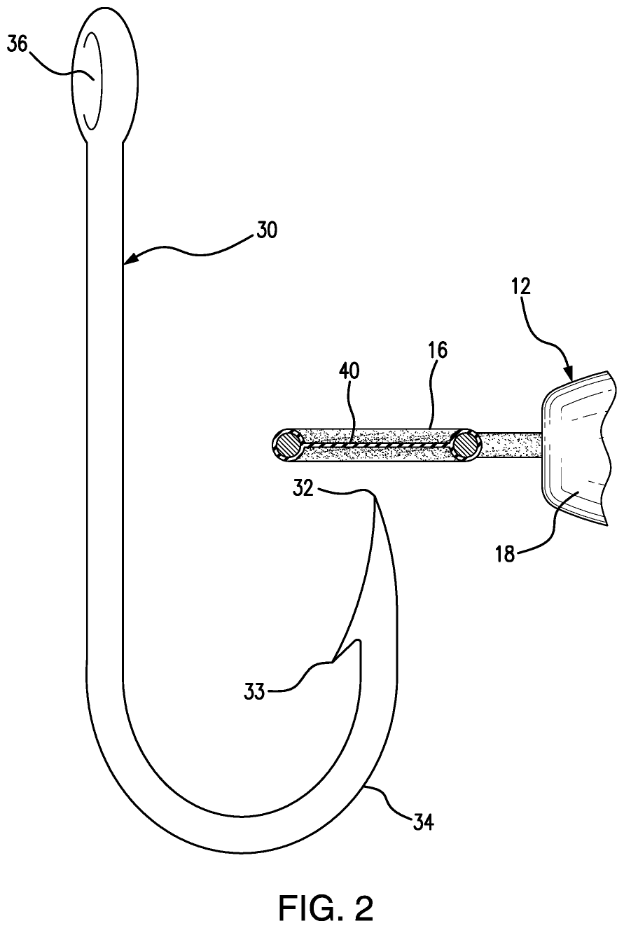

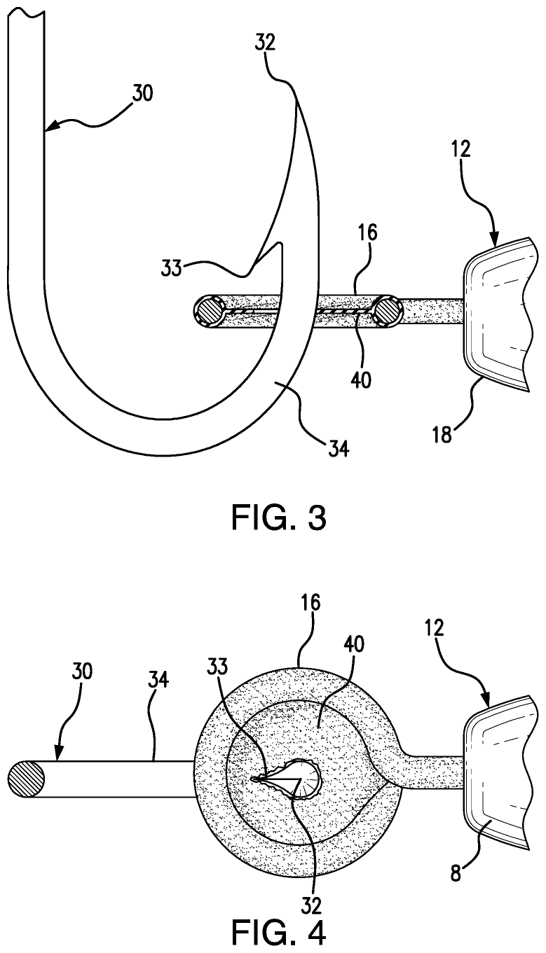

As seen in FIG. 1, the improved swivel 10 of the present invention is in the form of a barrel swivel 12 having opposite eyelets 14, 16 on either side of the central barrel member 18. A swivel mechanism within the barrel member 18, which is well known in the art, allows each eyelet 14, 16 to spin relative to the barrel member and independently of the opposite eyelet. One eyelet 14 is attached to rigging wire 20 used to attach the bait to the rig. The rig generally consists of the rigging wire 20, the barrel swivel 12 and a hook 30. The opposite eyelet 16 of the improved swivel 10 of the present invention is provided with a coating 40 creating a thin membrane (see FIGS. 2 and 3) that closes the eyelet 16, but yet allows for passage of the hook 30 therethrough, as seen in FIGS. 3 and 4. More specifically, the coating 40 (membrane) across the eyelet 16 opening is punctured by the hook point 32 while passing the hook 30 through the eyelet 16 while the coating 40 still grips the shank 34 of the hook 30. This allows for passage of the hook 30 through a larger size eyelet that prevents damage to the hook point 32 and barb 33, but yet eliminates unwanted sliding movement of the hook 30 relative to the swivel 10 when the bait 50 is attached to the rig, and particularly when trolling the bait 50 through the water. The coating 40 can be of any of a variety of different types of materials that provides for a grip effect on the shank 34 of the hook 30 so as to eliminate the unwanted sliding movement of the hook 30 through the eyelet 16. The invention contemplates us of any of a variety of known coatings that are presently available in the marketplace. The coating 40 can be applied to just one eyelet of the swivel or, alternatively, to both eyelets. The manner of application of the coating material to the swivel can be by any of a variety of methods, such as, but not limited to, spraying the coating material on the eyelet 16, or dipping the eyelet 16 (or both eyelets 14, 16) in the coating material.

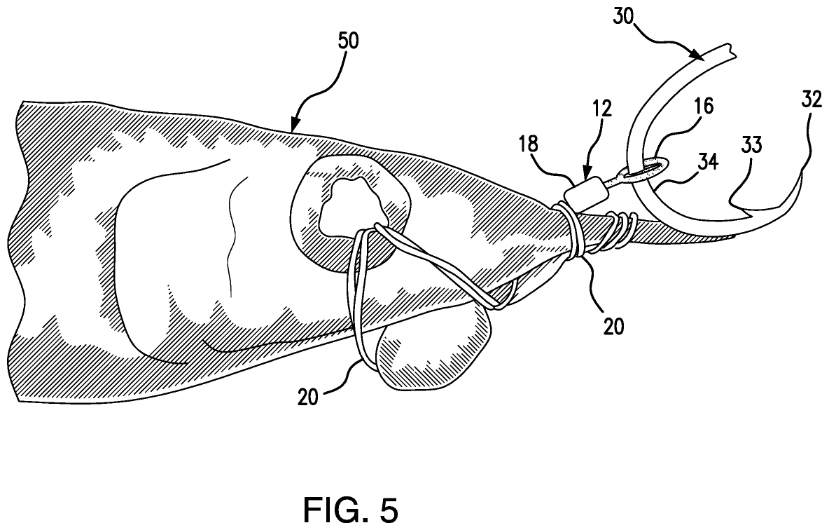

Referring to FIG. 5, a portion of a fishing rig is shown including the head portion of a dead bait (i.e., ballyhoo) and the swivel of the present invention, along with a fishing hook secured to the bill of the dead bait. As seen in FIG. 5, the pointed end 32 and barb 33 of the fishing hook 30 is passed through the membrane coating on the eyelet 16 of the swivel to hold the fishing hook in the desired orientation relative to the dead bait. The rigging wire 20 secured to the opposite eyelet of the swivel is wrapped around the dead bait to effectively secure the swivel and fishing hook to the dead bait. In particular, a ballyhoo rig is shown in FIG. 5, wherein the rigging wire 20 is wrapped around the base of the bill of the ballyhoo and through the eye socket, to thereby effectively hold the fishing hook 30 in the desired orientation on the bill of the ballyhoo bait.

What is claimed is:

1. A fishing tackle device comprising:
a central barrel member having a first end and opposite second end;
a first eyelet connected to the central barrel member through the first end;
a second eyelet connected to the central barrel member through the second end;
the first and second eyelets being structured and disposed to independently spin relative to the barrel member and one another; and
at least the first eyelet including a coating material applied thereto and forming a membrane that closes the eyelet.

2. The fishing tackle device as recited in claim 1 wherein the membrane formed by the coating material is structured and disposed to allow punctured passage of a pointed end and barb of a fishing hook therethrough while maintaining frictional engagement with the fishing hook.

3. The fishing tackle device as recited in claim 2 wherein the coating material includes a rubberized composition.

4. The fishing tackle device as recited in claim 3 wherein the second eyelet is structured and disposed for attachment of rigging wire thereto for rigging the fishing tackle device and the fishing hook to dead bait.
